(19) United States
(12) Patent Application Publication
(10) Pub. No.: US 2026/0030888 A1
(43) Pub. Date: Jan. 29, 2026

(54) AUTONOMOUS DETECTION OF MISSING, DAMAGED, ILLEGIBLE SIGNS

(71) Applicant: Schlumberger Technology Corporation, Sugar Land, TX (US)

(72) Inventors: Kishore Mulchandani, Menlo Park, CA (US); Ali Rezaei, Houston, TX (US); Nasser Ghorbani, Houston, TX (US); Bernard Van Haecke, Menlo Park, CA (US)

(21) Appl. No.: 18/781,253

(22) Filed: Jul. 23, 2024

(51) Int. Cl. G06V 20/52; G06F 40/30; G06V 10/75; G06V 10/98; G06V 20/62

(52) U.S. Cl. CPC G06V 20/52; G06F 40/30; G06V 10/751; G06V 10/98; G06V 20/63

(57) ABSTRACT

Methods, computing devices, and computer-readable storage media are provided. A computing device receives an image of a respective area of a facility, detects signage within the image, and maps the detected signage to the respective area represented in a map to produce a map of signs that is stored in a spatial data structure. Natural language processing with references to well-known symbols semantically understands information included on the signage, which is then stored. When one or more anomalies are determined to exist in the signage, information regarding the one or more anomalies is presented. An impact area of the signage is determined, if any. The received image is compared with a previously received image of the respective area to determine a difference. The computing device presents an indication of the difference.

### INTRODUCTION

The present disclosure describes autonomous detection of signage, including signage that is missing, damaged, illegible, obliterated, masked, peeled off, moved, blown away, washed out, or dirtied. Anomalies found in signage are reported as soon as they are detected.

### BACKGROUND

In a facility, anomalies in signage such as, for example, a damaged sign, an illegible sign, a masked sign, a peeled off sign, a moved sign, a blown away sign, a washed out sign, or a dirtied sign can raise Health, Safety, and Environmental (HSE) concerns. Such anomalies can possibly lead to accidental death or injury, as well as commercial losses.

Due to the hazardous consequences associated with anomalies in signage, such anomalies should be reported to one or more parties responsible for addressing HSE concerns as soon as they are detected. The impact of such anomalies can be much more detrimental during excavation. Such hazardous activities can be very disruptive and can lead to further losses regarding assets and personnel. Therefore, what is needed is an improved system and method for detecting missing, damaged, or illegible signs.

### SUMMARY

Embodiments of the disclosure may provide a computer-implemented method for detecting missing, damaged, or illegible signs. A computing device detects signage within an image of a respective area of a facility. The computing device maps the signage to the respective area represented in a map of the facility to produce a map of signs. Natural language processing, with references to well-known symbols, semantically understands information included on the signage. The computing device determines whether one or more anomalies exist in the signage within the image of the respective area. The computing device presents information regarding the one or more anomalies when the one or more anomalies are determined to exist. An impact area of the signage, if any, is determined by the computing device. The image of the respective area is compared with a previous image of the respective area to determine a difference. The comparing further compares associated data including any anomalies and impact areas associated with the image with any anomalies and impact areas associated with the previous image. The computing device presents an indication of the difference.

In an embodiment, the computer-implemented method further includes the computing device recording the difference, wherein the recording of the difference includes recording a geo-timestamp with the difference.

In embodiments of the disclosure, the one or more anomalies include any of sign damage, sign destroyed, sign masked, sign peeled off, sign moved, sign missing, and sign dirtied.

An embodiment of the disclosure may further include determining, by the computing device, a change in the impact area of a respective sign in the received image with respect to the previously received image, and presenting, by the computing device, a representation of the change in the impact area of the respective sign.

An embodiment of the disclosure may further include the computing device determining a change in location of a sign with an impact area, and determining, based on a text of the sign and the changed location of the sign, that the impact area of the sign remains unchanged.

An embodiment of the disclosure may further include the computing device determining whether the sign has temporal relevance, and when the sign is determined to have the temporal relevance, the computing device determines an action to be performed with respect to the temporal relevance. A notification with respect to the action to be performed is provided by the computing device.

In an embodiment of the disclosure the map is a geo-timeseries map. The computing device determines an evacuation path during a specified hypothetical event and the evacuation path is presented.

An embodiment of the disclosure may further include the computing device determining a conflict among impact areas of two or more signs and presenting a notification concerning the conflict among the impact areas.

Embodiments of the disclosure may also provide a computing device for detecting missing, damaged or illegible signs. The computing device includes a processor, a memory, and a bus connecting the processor and the memory. The memory includes instructions for the processor to perform operations. According to the operations, signage within an image of a respective area of a facility is detected and mapped to the respective area of the facility represented in a map of the facility to produce a map of signs. The map of signs is stored in a spatial data structure. Natural language processing with references to well-known symbols is performed to semantically understand information included on the signage. A determination is made regarding whether one or more anomalies exist in the signage within the image of the respective area. When the one or more anomalies are determined to exist, information is presented regarding the one or more anomalies. An impact area of the signage is determined, if any exist. The received image of the respective area is compared with a previous image of the respective area to determine a difference, which is recorded. The comparing further compares associated data including any anomalies and impact areas associated with the image with any anomalies and impact areas associated with the previous image. An indication of the difference is presented.

Embodiments of the disclosure may also provide a non-transitory computer-readable storage medium having instructions recorded thereon for a processor to perform operations. According to the operations, an image of a respective area of a facility is received and signage within the image is detected. The detected signage is mapped to the respective area of the facility represented in a map of the facility to produce a map of signs, which is stored in a spatial data structure. Natural language processing with references to well-known symbols is performed to semantically understand information included on the signage. The semantically understood information corresponding to the signage is stored. A determination is made regarding whether one or more anomalies exist in the signage within the image of the respective area. When the one or more anomalies are determined to exist, information regarding the one or more anomalies is presented. An impact area of the signage, if any, is determined. The received image of the respective area is compared with a previously received image of the respective area to determine a difference, which is recorded. The comparing further compares associated data including any anomalies and impact areas associated with the image with any anomalies and impact areas associated with the previous image. An indication of the difference is presented.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example environment in which embodiments of the disclosure may operate.

FIG. 2 illustrates an example computing device for implementing embodiments of the disclosure.

FIG. 3 shows an image of equipment having a danger sign attached thereto in an area of a facility.

FIG. 4 shows an image of equipment having a peeled sign that has directionality.

FIG. 5 shows an image of equipment having an illegible sign attached thereto.

FIG. 6 shows an impact zone or area that has expanded to include a gray area that could be less strict in enforcement or could be inherently ambiguous.

FIG. 7 shows four example instances of sign anomalies.

FIG. 8 is a flowchart of an example process for creating a map of signs.

FIGS. 9 and 10 are flowcharts of an example procedure for receiving images of signage in respective areas of a facility and determining and presenting changes or anomalies.

FIG. 11 is a flowchart of an example process for determining and presenting an evacuation path based on a selected hypothetical event.

FIG. 12 is a flowchart of an example process for determining whether a captured image has too few signs.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

In various embodiments, an image capturing device may capture images of various areas of a facility. A captured image can be a single image or a video frame. The image capturing device may be carried by a robot, which moves around the facility and captures images that include signage of the facility. In other embodiments, the image capturing device may be integrated into a system that autonomously moves about the facility and captures images that include the signage of respective areas of the facility.

The captured image may be received by a computing device. In some embodiments, the image capturing device may be integral to the computing device. The computing device may detect signage within the captured image using, for example, a trained machine learning model, an Artificial Intelligence (AI) model, a Convolutional Neural Network (CNN), a Recurrent Neural Network (RNN) or via other methods.

In various embodiments, a two-dimensional map or a three-dimensional map of the facility may have already been created. If the map of the facility had not already been created, a two-dimensional or a three-dimensional CAD model of the facility can be used to create the map. In some embodiments, a robotics or other solution may be used to create the map.

A location of the detected signage may be determined and mapped to a location represented in the map to produce a two or three-dimensional map of signs. In some embodiments, the image capturing device may include location information of a captured image that is provided to the computing device. The map of signs can be stored in a spatial data structure including, but not limited to a Geographic Information System (GIS) database or a geo-timeseries database for fast and easy retrieval.

Images of respective areas of the facility can be captured from time to time and stored information regarding the detected signs may be updated.

Detected signs from a currently captured image of a respective area of a facility can be compared with detected signs from a previously captured image of the respective area of the facility. The comparing further compares associated data including any anomalies and impact areas associated with the image with any anomalies and impact areas associated with the previous image. Differences can be recorded along with a geo-timestamp.

Natural Language Processing (NLP) using standard references to well-known symbols with respect to content of the detected signage may be performed to produce a semantic understanding of signs in the signage. In addition, at least some of the signs can have an impact area, which can be determined and recorded. For example, a sign that indicates a dangerous arca has an impact area in an area around the sign. A size of the impact area may be determined by a type of danger that may be discerned within an image that includes the sign. Some impact areas may not have definite boundaries. For example, a speed limit sign can have an impact arca that includes a piece of a pathway associated with the speed limit sign. A no smoking sign may have an impact area that includes a volume or area associated therewith.

In some embodiments, if a sign is determined to have changed its location, but its impact area or semantics have not changed by more than a predetermined amount, a notification of a changed impact area will not be provided in order to reduce an occurrence of false notifications. For example, if a detected sign's content includes “Danger 10 meters ahead” and later the detected sign's content includes “Danger 10 meters behind,” but the sign's location has moved to the “Ahead” location, the sign's impact area has not changed.

Some signs can have a temporal or time-related aspect to them. For example, an elevator inspection certification appearing in a captured image can have an expiration date. Using NLP and semantic understanding, whether an inspection is overdue or still valid can be determined. If the inspection is overdue, a notification may be presented indicating that the inspection is overdue. In another example, a sign displaying a maintenance schedule may be in a captured image. Using NLP and semantic understanding a notification regarding upcoming maintenance may be presented to a user as a reminder.

### Example Environment

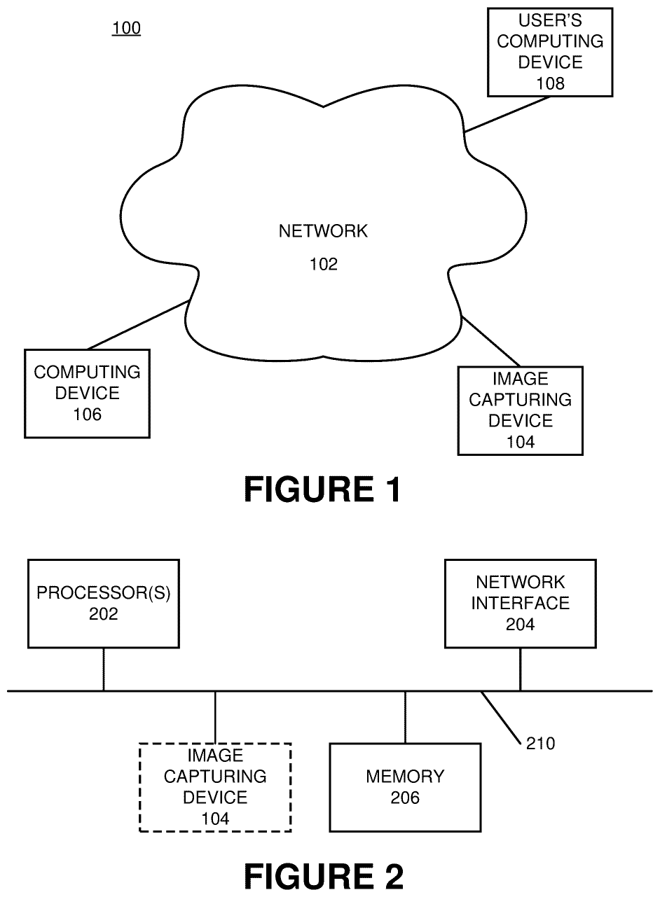

FIG. 1 shows an example environment 100 in which various embodiments may operate. Environment 100 may include, but not be limited to, a factory or other industrial or commercial environment that has areas of potential danger or possible health hazards. Environment 100 can include a network 102 and a an image capturing device 104, a computing device 106, and a user's computing device 108 connected to network 102. Network 102 may include a local area network (LAN), a wide area network (WAN), a public switched data network (PSDN), the Internet, an intranet, other types of networks, or any combination of the above. Image capturing device 104 may be a camera or other image capturing device capable of capturing images. Image capturing device 104 can have a wireless connection to network 102 and can be connected to computing device 106 via network 102. In some embodiments, image capturing device 104 can be carried by a robot throughout a facility to capture images of various areas of the facility having signage. In other embodiments, image capturing device 104 may be carried throughout the facility by an autonomous moving device while image capture device 104 captures images of the areas throughout the facility.

Computing device 106 may receive captured images from image capturing device 104 to produce a map of signs for the facility. The captured images may include location information with respect to the captured image.

### Example Computing Device

FIG. 2 shows an example computing device implemented in environment 100. The computing device could implement computing device 106 or user's computing device 108. The computing device may include one or more processors 202, a network interface 204, and a memory 206 connected to a bus 210. In some embodiments, image capturing device 104 can be integral to the computing device and connected to other components of the computing device via bus 210.

Bus 210 may represent one or more of a number of different bus structures including a memory controller or memory bus, a peripheral bus, an accelerated graphics port, a processor or local bus that uses any of a number of bus architectures such as, for example, an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus.

As described in FIG. 1, computing devices 106, 108 may include a variety of computer-readable storage media, which may include both volatile and non-volatile media, removable and non-removable media.

Memory 206 can include random access memory (RAM) and/or cache memory. Computing devices 106, 108 may further include other removable/non-removable, volatile/non-volatile computing device storage media (not shown). Memory 206 may include at least one program product having one or more program modules configured to carry out functions of various embodiments.

### Example Image

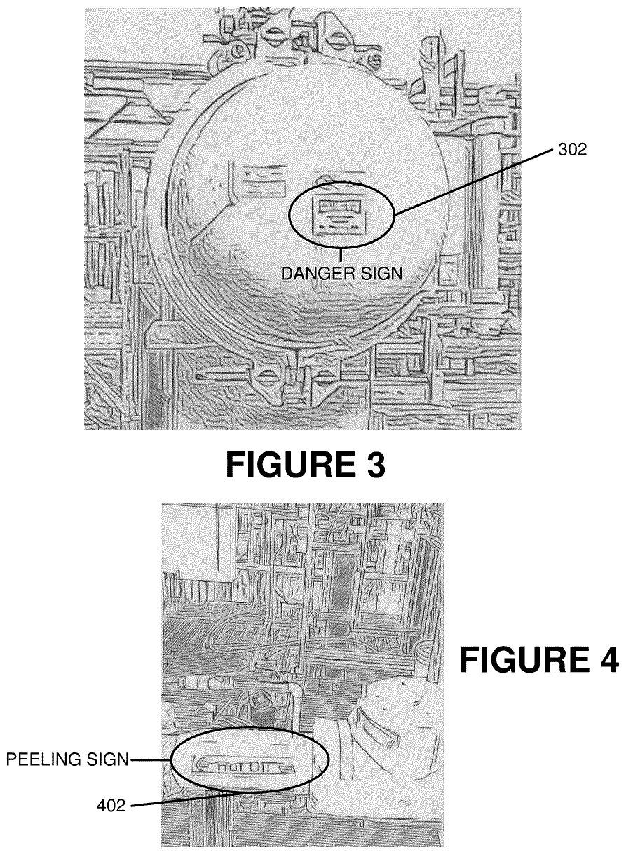

FIG. 3 shows an example image that may be captured by image capturing device 104, 208 according to embodiments. Using a trained machine learning model, an Artificial Intelligence (AI) model, a Convolutional Neural Network (CNN), a Recurrent Neural Network (RNN) or other methods, a sign 302 attached to equipment can be detected. NLP can be used to recognize content of the sign, which can indicate danger as well as other conditions, and a semantic understanding of sign 302 can be created and stored. Based on the semantic understanding of sign 302, an impact area indicating danger could be rendered around a representation of the equipment. If sign 302 were to become occluded or obscured in some way in a future captured image, an impact area indicating danger would not be rendered.

A difference between a currently captured image and a previously captured image would be highlighted and result in further investigation. For example, if a previously captured image includes a sign and a currently captured image is identical to the previously captured image except that the sign is missing, then an indication that the sign is missing may be displayed and highlighted, and further investigation may be performed.

### Example Image

FIG. 4 shows another example image that can be captured by image capturing device 104, 208 according to embodiments. Using a trained machine learning model, an Artificial Intelligence (AI) model, a Convolutional Neural Network (CNN), a Recurrent Neural Network (RNN) or other methods, a sign 402 can be detected as well as an anomaly such as a peeling sign. NLP can be used to recognize content of the sign “Hot Oil”, which indicates directionality.

### Example Image

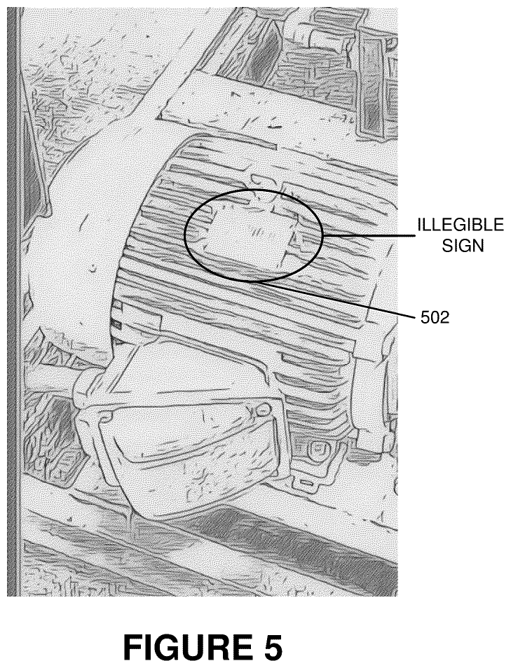

FIG. 5 shows a third example image that can be captured by image capturing device 104, 208 according to embodiments. Using a trained machine learning model, an Artificial Intelligence (AI) model, a Convolutional Neural Network (CNN), a Recurrent Neural Network (RNN) or other methods, a sign 402 can be detected as well as an anomaly such as an illegible sign 502.

Once a sign is detected and semantically understood, whether the sign has an impact area can be determined based on the semantic understanding. If the sign is determined to have an impact area, its impact area can be estimated. Impact areas can be used as “fences” or “geofences”.

### Example Impact Zone

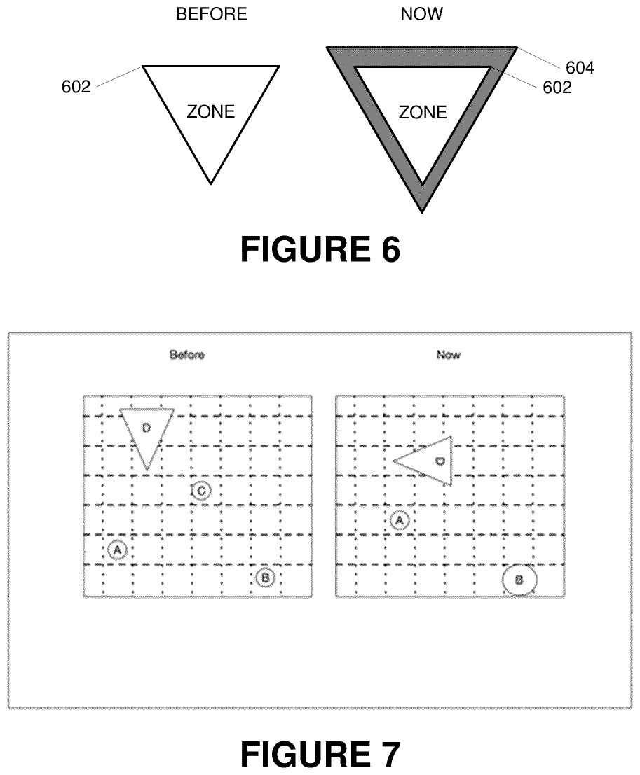

FIG. 6 shows an example impact zone or area 602 being grown to include a “gray area” 604. Gray area 604 could be less strict in enforcement or could be inherently ambiguous. For example, a sign near a hospital may state that loud noises are forbidden. In an area such as gray area 604, a noise lower than a first threshold noise level or a noise louder than the first threshold noise level having a duration less than a duration threshold may be acceptable, while a noise sounded repeatedly within gray area 604 might be considered a violation. However, in an area such as zone or area 602, a sound that exceeds a second threshold noise level, which may be lower than the first threshold noise level, may be considered a violation. In a zone or area without an associated gray area, a noise lower than a threshold noise level or a loud noise having a duration less than a duration threshold may be acceptable, while a noise sounded repeatedly might be considered a violation.

For three-dimensional directional signage, cones or frustums can be used as shapes to describe a scope or impact area of a sign. The impact area can be grown or shrunk by a threshold that can be arbitrarily defined or have statutory limits. For example, in an industrial setting, a sign may state “No Smoking within 100 meters” near a facility where combustible fluids are processed. The distance, 100 meters, may be dictated by law or a type of fluid being processed.

### Example Sign Anomalies

FIG. 7 shows an example of four instances of sign anomalies: sign “A” has changed location; sign “B's” impact area has grown; sign “C” has gone missing; and sign “D” has changed direction. For facilities, the map of signs may be represented either in two-dimensions or three-dimensions. The two-dimensions may represent latitude and longitude, or may be relative x, y coordinates with respect to an arbitrary origin. Orientation of the signage may be represented as a direction vector. Not all signs have directionality. For example, an exit sign on top of a door does not have an explicit directionality, but does have an implied direction. An exit sign pointing to a stairway has an explicit directionality. When meaningful, explicit and implicit directionality is tracked.

For non-directional signage, circles or other two-dimensional shapes may be used when the impact area is two-dimensional. Directional signage may have an arbitrary shape, with the shape being deformed proportional to a strength in the sign's direction. An example of such directional signage could be a “blast” or “flood” zones. Work or maintenance areas may have completely arbitrary shapes. Signage on equipment may refer to surfaces that could be hot or cold. Directionality there could refer to the flow direction.

### Example Process for Creating a Map of Signs

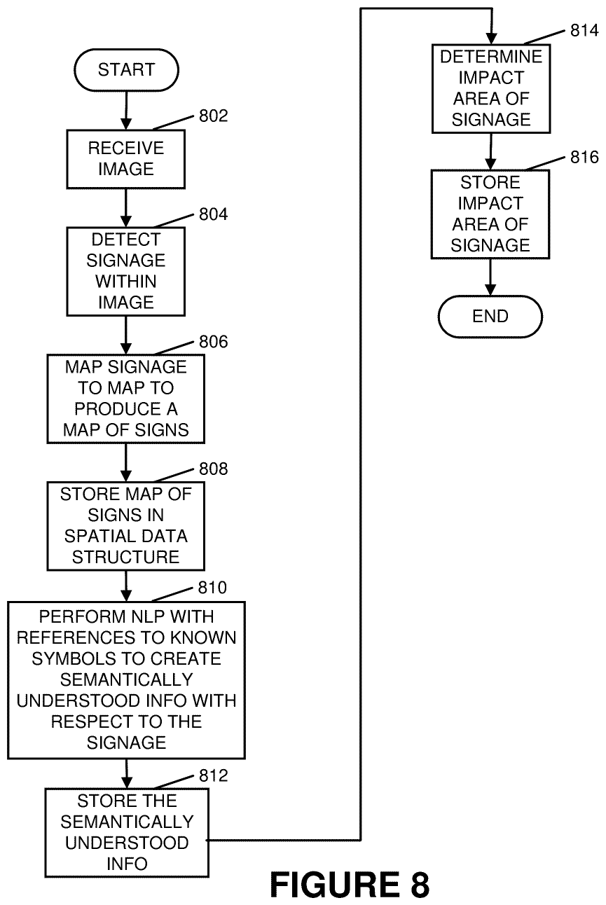

FIG. 8 is a flowchart of an example process for creating a map of signs. The process may begin with computing device 106 receiving a captured image from an image capturing device 104 (step 802). Signage within the captured image can be detected by computing device 106 by using a trained machine learning model, an AI model, a CNN, an RNN or via other methods (step 804).

In various embodiments, a two-dimensional or a three-dimensional map of a facility may have already been created. Otherwise, a two-dimensional or three-dimensional Computer Aided Design (CAD) model of the facility or a robotics solution can be used to create the map of the facility. For example, a robot mounted with a LIDAR sensor could collect point cloud images from various viewpoints. The point cloud images could be combined in a coherent manner to create a full three-dimensional point cloud image or a three-dimensional map of the facility. Similar operations can be done with RGB color images taken from photographic cameras.

The detected signage may be mapped to the map of the facility, using location information that may be included with the captured image, to produce a map of signs (step 806). The map of signs then may be stored in a spatial data structure such as, for example, a GIS database or a geo-timeseries database for fast and easy retrieval, or another type of data structure (step 808).

NLP with references to known symbols can be performed to create semantically understand information with respect to the signage (step 810). The semantically understood information then can be stored with respect to the signage (step 812).

An impact area, if any, of signs of the signage can be determined based on a machine learning model, an AI model, a CNN model, an RNN model, or another type of model (step 814). For example, a danger zone could have an impact zone of a preconfigured size and shape. In some embodiments, a size and shape of an impact area may be based on a type of danger as interpreted by semantically understood information of the sign as well as a surrounding area of the danger zone. As another example, a speed limit sign can have an impact area including a road on which the sign is detected, a directionality of the sign, and other signs found along the road, which would require a change in the speed along the road such as, for example, a sign that reads “Caution Men Working Ahead”. The determined impact area of signs can then be stored with respect to the corresponding signs (step 816).

Because a sign and its semantically understood information is stored, signage conflicts can be detected, which could be useful in removing confusion. Sign locations coupled with three-dimensional maps could be used to determine if corresponding signs are visible at critical junctures. Too many or too few signs could also be detected.

### Example Procedure for Receiving Images of Signage

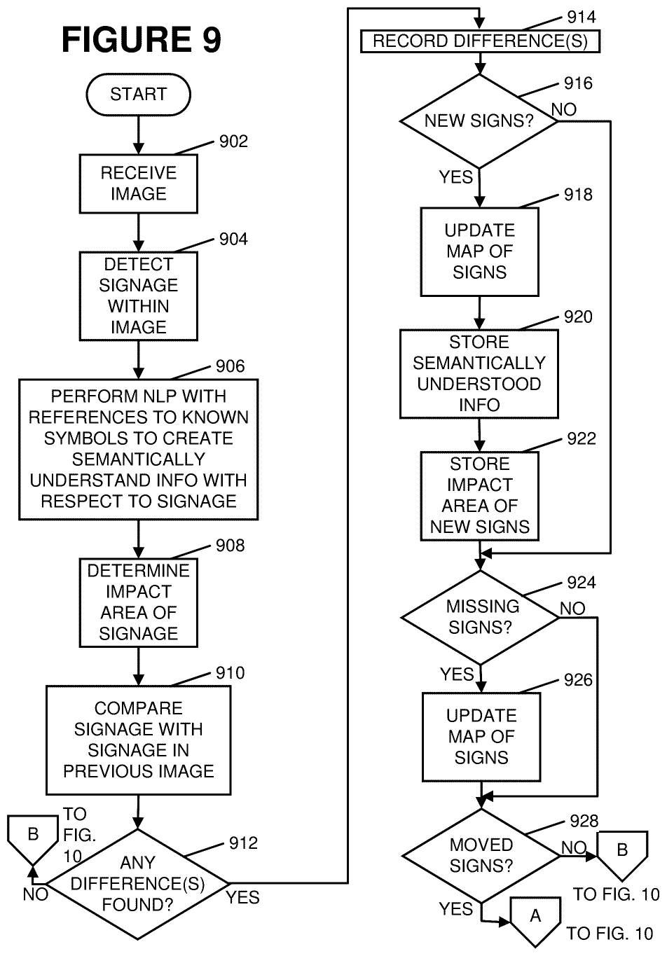

FIG. 9 shows an example flowchart of a procedure for periodically receiving images of signage in respective areas of a facility and determining and presenting changes or anomalies. The process may begin with receiving an image from an image capturing device 104, 208 capturing an image in a facility (step 902).

Computing device 106 may detect signage in the captured image by using, for example, a first trained machine learning model, a first Artificial Intelligence (AI) model, a first Convolutional Neural Network (CNN), a first Recurrent Neural Network (RNN) or via other methods. Some anomalies in the signage may be detected by using, for example, a second trained machine learning model, a second AI model, a second CNN, a second RNN, of via other methods (step 904).

Next, NLP may be performed with reference to known symbols, regarding contents of signs of the signage to create semantically understood information (step 906). Impact areas of the signage can then be determined as previously described with respect to step 814 of FIG. 8 (step 908).

Signs of the signage can then be compared to corresponding signs from a previously captured image to determine any differences (step 910). The comparing further compares associated data including any anomalies and impact areas associated with the detected signs in the image with any anomalies and impact areas associated with the signs in the previous image. New anomalies may be detected as a result of the comparing. For example, a missing or moved sign as well as an obstructed sign may be detected as well as other anomalies.

If, during step 912, any differences were found, then the differences with respect to the corresponding signs of a most recently captured image may be recorded (step 914). Whether new signs are detected in a most recently captured image then may be determined (step 916). If one or more new signs are detected, then the map of signs can be updated to include locations of the one or more new signs (step 918). The semantically understood information regarding the one or more new signs can then be stored (step 920) and the determined impact areas, if any, of the one or more new signs can then be stored (step 922).

If step 922 has been performed, or during step 916 no new signs are detected, then step 924 may be performed to determine whether one or more signs from the previously captured image are missing in the most recently captured image (step 924). If one or more missing signs are detected, the map of signs will be updated to reflect this (step 926).

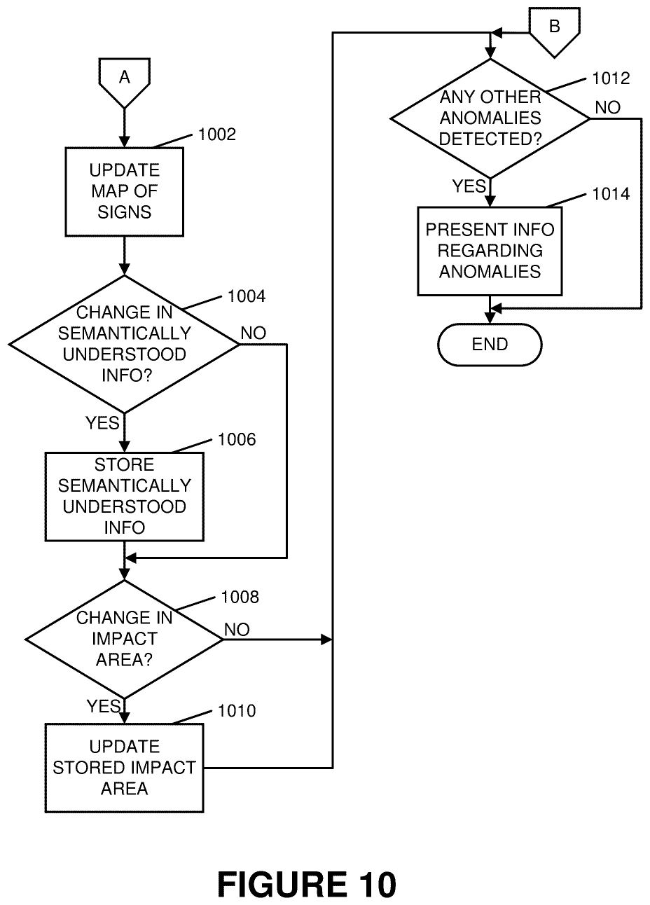

If during step 924 no missing signs were detected, or after updating the map of signs during step 926, a determination can be made regarding whether any signs have been moved (step 928). If any signs were determined to have been moved, the map of signs is updated (step 1002; FIG. 10).

Whether a change in the semantically understood information regarding the signage is determined (step 1004). If the change in the semantically understood information is detected during step 1004, then the semantically understood information can be stored with respect to corresponding signs of the signage (step 1006).

If during step 1004 a change in the semantically understood information is not detected, or after the changed semantically understood information is stored in step 1006, then a determination is made regarding whether any signs in the signage have a changed impact area (step 1008). For example, a changed impact area may be detected if a sign having an impact arca is moved or content of the sign has changed resulting in changed semantically understood information. If the changed impact area is determined, then the stored impact area of the affected signs can be updated (step 1010).

After determining that no change in any impact areas have been detected during step 1008, or after updating the stored impact areas of signs with changed impact areas, a determination is made regarding whether any other anomalies have been detected such as, for example, expiration of a sign's temporal relevance, a conflict with respect to impact areas of two or more signs, etc. (step 1012). An example of an expiration of a sign's temporal relevance includes detection of an elevator inspection sign having an expiration date that had already occurred. An example of a conflict in impact areas of signs includes one sign having a impact area indicating danger and another sign having an impact area indicating a safe arca overlapping with the impact area indicating danger.

If other anomalies are detected during step 1012, then information regarding any other anomalies detected may be presented to a user via user's computing device 108 or may appear in a report that may be provided to a user via email, text message, phone call, or other means (step 1014). In some embodiments, the user's computer may receive and present the information via a web browser or an application.

If, during step 1012, no other anomalies have been detected, then the process may be completed.

In an embodiment, a user may select a hypothetical event from a user's computing device, which can send an indication of the selected hypothetical event to computing device 106. Computing device 106 may receive the indication of the selected hypothetical event and can determine and present an evacuation route.

### Example Process for Determining and Presenting an Evacuation Route

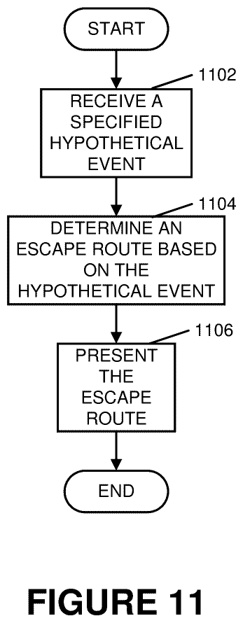

FIG. 11 shows a flowchart of an example process in an embodiment for determining and presenting an evacuation route based on a selected hypothetical event. The process may begin with a user's computing device 108 receiving a specified hypothetical event that is sent to computing device 106 via network 102 (step 1102). Computing device 108 may then determine an evacuation route based on the hypothetical event and impact areas of signs throughout a facility (step 1104). Computing device 106 can then send the evacuation route to user's computing device 108 for presentation to a user (step 1106). In an alternative embodiment, computing device 106 may provide the evacuation route to the user via email, text message, phone call, or via other method. The evacuation route may be determined as part of a training exercise or may be dynamically determined upon detecting a dangerous situation. For example, a dangerous event could be detected by stationary sensors mounted around a facility that could be connected with edge devices that could analyze and broadcast a location of the event to computing device 106. As an example, a dark smoke cloud emanating from a piece of equipment would be detected by a sensor having a known location. The location could be used to pinpoint a position of the event and the event could then be used to dynamically create a new exit route. This is similar to traffic re-routing when an accident occurs on a freeway.

In some embodiments, an evacuation pathway in a walkway of a building may be illuminated based on receiving a command from computing device 106 after a dangerous event is detected.

### Example Process for Determining Too Few Signs

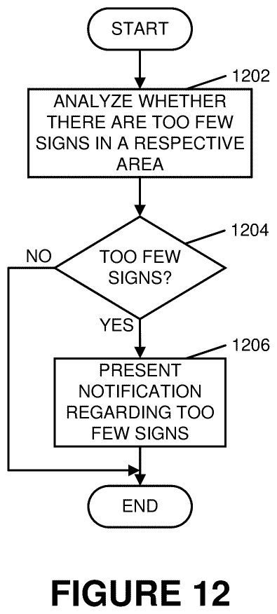

FIG. 12 is a flowchart of an example process for determining whether there are too few signs in a captured image. The process may begin with computing device 106 determining whether there are too few signs in a captured image (step 1202). To make this determination, computing device 106 may analyze multiple images of multiple areas of a facility. For example, if a group of signs include directions to a location and a distance between such signs exceeds a threshold, then too few signs may be detected.

In step 1204, computing device 106 determines whether too few signs have been detected. If too few signs have been detected, then a notification may be sent to user's computing device 108 for presentation to a user (step 1206) and the process is completed. In an alternative embodiment, the notification may be sent to the user via an email, a text message, a phone call, or via another method. If too few signs have not been detected during step 1204, then the process may be completed.

The foregoing description, for purpose of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

Various embodiments provide many advantages. For example, the embodiments provide signage anomaly detection and help to ensure consistency among the signage. Inadequate signage can be detected and a user notified. Autonomous signage anomaly detection is provided so that a user could be notified and correction of signage anomalies can occur as soon as possible. In addition, evacuation paths can be determined either on a requested basis or dynamically.

What is claimed is:

1. A computer-implemented method for detecting missing, damaged, or illegible signs, the computer-implemented method comprising:
detecting signage within an image of a respective area of a facility;
mapping the detected signage to the respective area of the facility represented in a map of the facility to produce a map of signs;
performing natural language processing with references to well-known symbols to semantically understand information included on the signage;
determining whether one or more anomalies exist in the signage within the image of the respective area;
presenting information regarding the one or more anomalies when the one or more anomalies are determined to exist;
determining an impact area of the signage if any;
comparing the image of the respective area with a previous image of the respective area to determine a difference, the comparing further including comparing associated data including any anomalies and impact areas associated with the image with any anomalies and impact areas associated with the previous image; and
presenting an indication of the difference.

2. The computer-implemented method of claim 1, further comprising:
recording the difference, wherein:
the recording the difference includes recording a geo-timestamp with the difference.

3. The computer-implemented method of claim 1, wherein the one or more anomalies include any of sign damage, sign destroyed, sign masked, sign peeled off, sign moved, sign missing, and sign dirtied.

4. The computer-implemented method of claim 1, further comprising:
determining a change in the impact area of a respective sign in the received image with respect to the previously received image; and
presenting a representation of the change in the impact area of the respective sign.

5. The computer-implemented method of claim 4, further comprising:
determining a change in location of a sign with an impact area; and
determining, based on a text of the sign and the changed location of the sign, that the impact area of the sign remains unchanged.

6. The computer-implemented method of claim 1, further comprising:
determining whether the sign has temporal relevance;
when the sign is determined to have the temporal relevance, determining an action to be performed with respect to the temporal relevance; and
providing a notification with respect to the action to be performed.

7. The computer-implemented method of claim 1, wherein:
the map is a geo-timeseries map; and
the computer-implemented method further comprises:
determining an evacuation path during a specified hypothetical event; and
presenting the evacuation path.

8. The computer-implemented method of claim 1, further comprising:
determining a conflict among impact areas of a plurality of signs; and
presenting a notification concerning the conflict among the impact areas.

9. A computing device for detecting missing, damaged, or illegible signs, the computing device comprising:
a processor;
a memory; and
a bus connecting the processor and the memory, wherein the memory includes instructions for the processor to perform operations comprising:
detecting signage within an image of a respective area of a facility,
mapping the detected signage to the respective area of the facility represented in a map of the facility to produce a map of signs,
storing the map of signs in a spatial data structure,
performing natural language processing with references to well-known symbols to semantically understand information included on the signage,
determining whether one or more anomalies exist in the signage within the image of the respective area,
presenting information regarding the one or more anomalies when the one or more anomalies are determined to exist,
determining an impact area of the signage if any,
comparing the image of the respective area with a previous image of the respective area to determine a difference, the comparing further including comparing associated data including any anomalies and impact areas associated with the image with any anomalies and impact areas associated with the previous image,
recording the difference, and
presenting an indication of the difference.

10. The computing device of claim 9, wherein:
the recording the difference includes recording a geo-timestamp with the difference.

11. The computing device of claim 9, wherein the one or more anomalies include any of sign damage, sign destroyed, sign masked, sign peeled off, sign moved, sign missing, and sign dirtied.

12. The computing device of claim 9, wherein the operations further comprise:
determining a change in the impact area of a respective sign in the received image with respect to the previously received image; and
presenting a representation of the change in the impact area of the respective sign.

13. The computing device of claim 9, wherein the operations further comprise:
determining a conflict among impact areas of a plurality of signs; and
presenting a notification concerning the conflict among the impact areas.

14. The computing device of claim 9, wherein the operations further comprise:
determining that there are too few signs in the respective area; and
presenting a notification when the too few signs are determined.

15. The computing device of claim 9, wherein the operations further comprise:
determining a directionality of a sign in the image of the respective area of the facility, wherein:
directional signage is presented as an arbitrary shape that is deformed proportional to a directional strength.

16. A non-transitory computer-readable storage medium having instructions recorded thereon for a processor to perform operations, wherein the operations comprise:
receiving an image of a respective area of a facility;
detecting signage within the image;
mapping the detected signage to the respective area of the facility represented in a map of the facility to produce a map of signs;
storing the map of signs in a spatial data structure;
performing natural language processing with references to well-known symbols to semantically understand information included on the signage;
storing the semantically understood information corresponding to the signage;
determining whether one or more anomalies exist in the signage within the image of the respective area;
presenting information regarding the one or more anomalies when the one or more anomalies are determined to exist;
determining an impact area of the signage if any;
comparing the received image of the respective area with a previously received image of the respective area to determine a difference, the comparing further including comparing associated data including any anomalies and impact areas associated with the image with any anomalies and impact areas associated with the previous image;
recording the difference; and
presenting an indication of the difference.

17. The non-transitory computer-readable storage medium of claim 16, wherein the operations further comprise:
storing information regarding the impact area of the signage.

18. The non-transitory computer-readable storage medium of claim 16, wherein the map of signs is either a two dimensional map or a three dimensional map.

19. The non-transitory computer-readable storage medium of claim 16, wherein the operations further comprise:
using cones or frustums on a three dimensional map of signs to describe the impact area of the signage.

20. The non-transitory computer-readable storage medium of claim 16, further comprising:
determining a conflict among impact areas of a plurality of signs; and
presenting a notification concerning the conflict among the impact areas.
